(19) United States
(12) Patent Application Publication
(10) Pub. No.: US 2023/0312305 A1
(43) Pub. Date: Oct. 5, 2023

(54) Device and Method for Elevator Scheduling

(71) Applicants: Casey Curtis, Los Angeles, CA (US); Casey Daleiden, Bloomington, IN (US); Matteo Vidali, Bloomington, IN (US)

(72) Inventors: Casey Curtis, Los Angeles, CA (US); Casey Daleiden, Bloomington, IN (US); Matteo Vidali, Bloomington, IN (US)

(21) Appl. No.: 18/193,447

(22) Filed: Mar. 30, 2023

Related U.S. Application Data
(60) Provisional application No. 63/325,301, filed on Mar. 30, 2022.

(51) Int. Cl. B66B 1/46; B66B 1/02; B66B 1/34; B66B 1/52

(52) U.S. Cl. CPC B66B 1/468; B66B 1/02; B66B 1/3461; B66B 1/52; B66B 1/3492; B66B 2201/103; B66B 2201/4653; B66B 2201/4615; B66B 2201/4638; B66B 2201/463

(57) ABSTRACT

An elevator has an elevator scheduling assembly. The elevator scheduling assembly may include elevator controllers that pressure elevator buttons to call an elevator car to a floor in a building. The elevator scheduling assembly may also include a mobile user controller that allows a user to remotely call an elevator car.

### CROSS REFERENCE TO RELATED APPLICATIONS

This application claims the benefit of U.S. Provisional Patent Application No. 63/325,301, filed on Mar. 30, 2022, and entitled “Device and Method for Elevator Scheduling,” to Curtis et al., the complete disclosure of which is expressly incorporated by reference herein.

### TECHNICAL FIELD

The present disclosure generally relates to a device and method for elevator scheduling. More particularly, the present disclosure relates to a device and method for elevator scheduling wherein a user's controller transmits an elevator call.

### BACKGROUND

This section introduces aspects that may help to facilitate a better understanding of the disclosure. Accordingly, these statements are to be read in this light and are not to be understood as admissions about what is or is not prior art.

Many buildings contain elevators to transport passengers from one floor to another. Conventionally, elevator systems operate by requiring passengers to call an elevator by pressing an up/down push button immediately outside the elevator to indicate the desired direction of travel. The passengers then have to wait for the elevator to arrive on the passengers' pick-up floor before entering the elevator and selecting the desired drop-off floor. In addition to requiring that the passenger wait for the elevator to arrive in the elevator's immediate proximity, the conventional method requires passengers to regularly come in contact with the elevator buttons.

According to the present disclosure, an elevator scheduling assembly is provided. The assembly comprises a computer configured to control elevator calls and an elevator controller positionable to operate an elevator button to call an elevator car to a floor of a building in response to instructions from the computer.

According to another aspect of the present disclosure, an elevator controller is provided. The elevator controller comprises a receiver configured to receive an elevator call signal and an actuator in communication with the receiver and positionable to press an elevator button in response to receiving the elevator call signal.

According to another aspect of the present disclosure, an elevator is provided. The elevator comprises an elevator car system, an elevator control system configured to control the elevator car system, an elevator movement input, and a computer in communication with the elevator movement input to receive information from the elevator movement input to detect movement of the elevator car system without communication from the elevator control system relating to control of elevator car system through elevator control system.

According to another embodiment of the present disclosure, an elevator is provided. The elevator comprises an elevator car system, an elevator control system configured to control the elevator car system, an elevator controller including a receiver configured to receive an elevator call signal and an actuator in communication with the receiver and positionable to press an elevator button in response to receiving the elevator call signal. The elevator controller includes an elevator movement input. The elevator further comprises a plurality of doors positioned on floors of a building, the elevator control system includes a plurality of elevator buttons including up and down elevator buttons positioned adjacent to the plurality of doors. The elevator movement input is positioned to detect movement of the elevator car system relative to a floor of the building.

According to another aspect of the present disclosure, a method for calling an elevator is provided. The method comprising the steps of providing an elevator in a building with a plurality of floors, the elevator having an elevator car system and an elevator scheduling assembly, observing elevator high use patterns using the elevator scheduling assembly, the elevator high use patterns including times and floors of high elevator car pickups, and moving an elevator car of the elevator car system to a floor using the elevator high use patterns.

According to one aspect of the present disclosure, a scheduling device assembly for elevator calling is provided. The scheduling device assembly includes an intermediate computing device that has memory storing instructions that cause the intermediate computing device to receive an elevator call from a user's controller (mobile phone), create an electronic ticket based on the elevator call, and transmit the ticket to an elevator controller. The elevator controller has memory storing instructions that cause the elevator controller to add the ticket to a queue of an elevator. Once a current time matches a pick-up time on the ticket, the elevator controller selects a pick-up floor button to pick up the user.

According to one aspect of the present disclosure, an elevator scheduling method is provided. The method includes a step of a user opening an application, a step of the application loading elevator data, a step of the user selecting a pick-up floor, a step of the user selecting a drop-off floor, a step of the user selecting a pick-up time, a step of an intermediate computing device receiving an elevator call, a step of the intermediate computing device storing the elevator call, a step of the intermediate computing device creating an electronic ticket based on the elevator call, a step of the intermediate computing device selecting an elevator, a step of the intermediate computing device sending the ticket to an elevator controller, a step of the elevator controller saving the ticket, a decision step where the ticket time is compared to the current time, a step of the elevator controller selecting a pick-up floor button, a step of the elevator picking up the user, a step of the elevator controller selecting a drop-off floor button, a step of the elevator dropping off the user, and a step of the intermediate computing device storing data.

### BRIEF DESCRIPTION OF THE DRAWINGS

The detailed description of the drawings particularly refers to the accompanying figures in which:

FIG. 1a is a cross-sectional view of a building with an elevator and four floors, which may be a pick-up floor or a drop-off floor depending on a current location of a user and a desired future location of the user.

FIG. 1b is an enlarged view of a portion of the building of FIG. 1a showing the elevator of FIG. 1a, including a floor button panel on an interior of the elevator;

FIG. 2a is a front view of one embodiment of the elevator controller of FIG. 1b;

FIG. 2b is a front view of an additional embodiment of the elevator controller of FIG. 1b;

FIG. 3 is a diagrammatic view of an interaction between a user's controller, an intermediate computing device, and the elevator controller of FIG. 2a or FIG. 2b; and

FIG. 4 is a flow chart showing an elevator scheduling method for pick-up and drop-off of the user.

FIG. 5 is a perspective view of an elevator controller including a housing and pivoting lever.

FIG. 6a is a side view of the elevator controller of FIG. 5 showing the lever vertically aligned with up and down buttons of an elevator panel.

FIG. 6b is the view similar to FIG. 6a showing the lever vertically and horizontally aligned with the up and down buttons of the elevator panel and positioned to press the up and down buttons of the elevator panel.

FIG. 7 is a side view of an alternative embodiment of elevator controller including a housing that complements the elevator panel of FIG. 6a and a lever positioned to press up and down buttons of the elevator panel.

For the purposes of promoting and understanding the principles of the disclosure, references will now be made to the embodiments illustrated in the drawings, which are described below. The embodiments disclosed below are not intended to be exhaustive or limit the disclosure to the precise form disclosed in the written description. Rather, the embodiments are chosen and described so that others skilled in the art may utilize their teachings. Unless otherwise indicated or apparent, the components shown in the figures are proportional to each other. It will be understood that no limitation of the scope of the disclosure is thereby intended. The disclosure includes any alterations and further modifications in the illustrative devices and described methods and further applications of the principles of the disclosure, which would normally occur to one of skill in the art to which the disclosure relates.

### DETAILED DESCRIPTION OF THE DRAWINGS

According to the present disclosure, a scheduling device assembly 28 and elevator scheduling method 110 are provided that allow a user to schedule an elevator 16 of a building 12 in advance of arriving at elevator 16. Additionally, scheduling device assembly 28 and elevator scheduling method 110 may allow the user to avoid touching up/down buttons 22′, 22″ to call elevator 16 at a pick-up floor 14 and/or select a drop-off floor 10 on a floor button panel 18.

According to one aspect of the present disclosure, scheduling device assembly 28 performs all or portions of elevator scheduling method 110. Scheduling device assembly 28 includes an intermediate computing device/computer 34 having a memory 40 storing instructions that cause intermediate computing device 34 to receive an elevator call from a mobile user controller 32, create an electronic ticket based on the elevator call data, and transmit the ticket to an elevator controller 20. Elevator controller 20 has a memory 44, storing instructions that cause elevator controller 20 to add the ticket to a queue for elevator 16.

According to the present disclosure, elevator scheduling method 110 is provided to aid the user in calling an elevator car 15 of elevator 16. Method 110 increases elevator efficiency by decreasing elevator wait time. Method 110 also helps to maintain elevator cleanliness by allowing the user to call elevator 16 in a hands-free process.

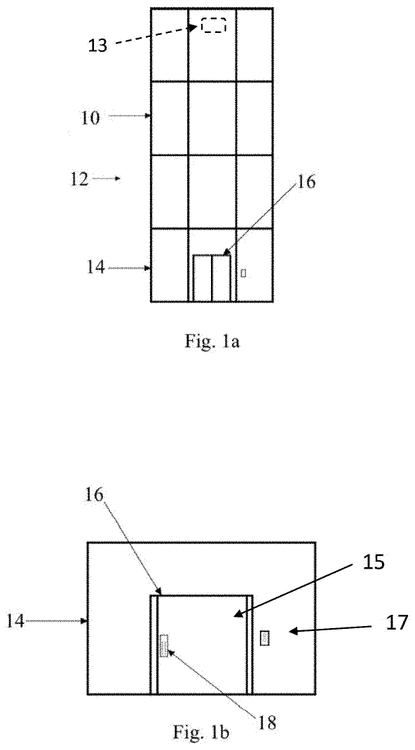

FIG. 1a shows elevator 16 within building 12. Elevator car 15 picks up the user on pick-up floor 14 on which the user is located and drops off the user on drop-off floor 10 where the user desires to be dropped off. Pick-up floor 14 and drop-off floor 10 are both within building 12. Although only one elevator 16 is depicted, building 12 may have multiple elevators 16. Elevator car 15 is a component of an elevator car system that may also include cables, drums, electric motors, counterweights, brakes, etc.

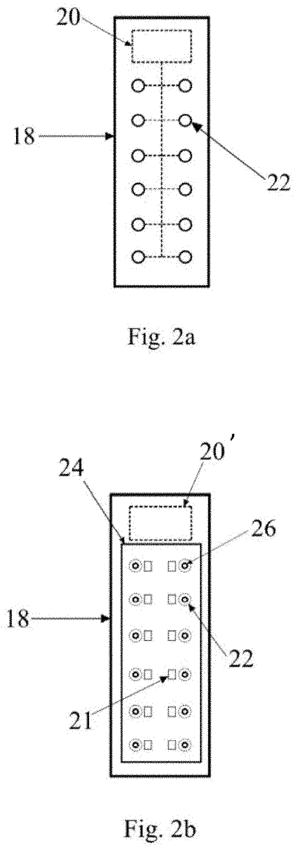

Elevator 16 with open doors is shown on pick-up floor 14 in FIG. 1b. Elevator controller 20 is located within elevator 16, specifically elevator controller 20 is located underneath/internally of a multi-floor button panel 18 within elevator 16. In this embodiment, elevator controller 20 may not be visible to the user. For illustrative purposes, floor button panel 18 is shown in the back of elevator car 15 rather on the door side of elevator car 15. In another embodiment, elevator controller 20′ (see FIG. 2b) is located on top of and external to floor button panel 18 within elevator 16. In this embodiment, elevator controller 20′ may be visible to the user.

In FIG. 2a, an embodiment of elevator controller 20 is shown. Unless otherwise indicated, the operation, features, etc. of the various elevator controllers 20, 20′, 20″, 20′″ etc. are also descriptive of the other elevator controllers 20, 20′, 20″, 20′″ etc. disclosed herein. Elevator controller 20 receives the electronic ticket, which includes the user's indicated pick-up floor 14, drop-off floor 10, and the pick-up time, from intermediate computing device/computer 34 and adds the ticket to the queue for elevator 16. In this embodiment, elevator controller 20 is located underneath and interior to floor button panel 18 within elevator 16. Elevator controller 20 is hardwired to floor button panel 18. Elevator controller 20 transmits a signal to floor button panel 18 through hardwiring to select drop-off floor 10. The signal directs elevator 16 to drop-off floor 10. According to one embodiment, the signal also causes a floor button 22 on floor button panel 18, which corresponds to drop-off floor 10, to illuminate.

In one embodiment, controller 20 does not communicate with an elevator control system 13 that operates one or more elevators 16 of building 12. Typically, elevator control system 13 is installed at the original installation of elevator(s) 16 in building 12. As such, controller 20 and a computer 34 communicate independently of elevator control system 11 and operate elevator(s) 16 independently of elevator control system 13. Thus, elevator(s) 16 of building 12 can be operated without reliance on and/or modification of elevator control system 13. According to another embodiment, controller 20 may communicate with elevator control system 13.

Another device for selecting drop-off floor 10 is provided by elevator controller 20′ shown in FIG. 2b. In this embodiment, elevator controller 20′ includes an external panel/housing 24, a plurality of electronically operated devices 21, and a selection mechanism 26.

External panel 24 is located on top of and exterior to floor button panel 18 within elevator 16 and compliments floor button panel 18 in size and/or shape. Elevator controller 20′ may select/press floor button 22 to direct elevator 16 to travel to drop-off floor 10. Electronically operated devices 21 press floor button 22 on floor button panel 18 when commanded by elevator controller 20′ to select the desired drop-off floor 10. Electronically operated devices 21 may be servos, solenoids, other electromechanical devices, etc. capable of pushing/pressing floor button 22. When commanded by elevator controller 20′ in response to the ticket from intermediate computing device 34, one or more electronically operated devices 21 are energized and press floor button 22 corresponding to selected drop-off floor 10. For example, if the user is located on a first floor of building 12 and desires to travel to a fourth floor, elevator controller 20′ will instruct electronically operated devices 21 associated with a first floor button 22 to press first floor button 22. As a result, elevator 16 will travel to the first floor, the user's indicated pick-up floor 14, to pick up the user. Next, elevator controller 20′ will instruct electronically operated devices 21 associated with a fourth floor button 22 to press fourth floor button 22. Then, elevator 16 will travel to the fourth floor, the user's indicated drop-off floor 10, to drop off the user.

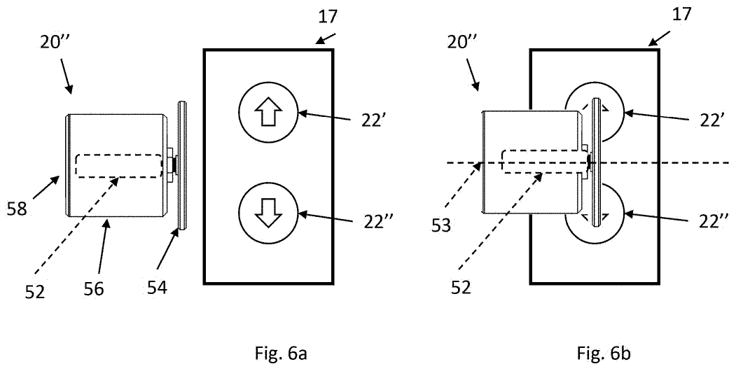

External panel 24 may also transmit a second user's attempt to press floor button 22 if the second user does not use scheduling device assembly 28 and, instead, wishes to manually press floor button 22. When the second user is present in elevator 16 and wants to select drop-off floor 10 by selecting floor button 22, the second user presses selection mechanism 26, which appears as a button on external panel 24. Selection mechanism 26 is aligned with floor button 22. Selection mechanism 26 presses floor button 22 on floor button panel 18 when selection mechanism 26 is pressed by the second user. The pressure put on selection mechanism 26 by the second user's press causes selection mechanism 26 to press into floor button 22 associated with the selected floor. As a result, when selection mechanism 26 is pressed by the second user, underlying floor button 22 is also pressed so that selection mechanism 26 works to transmit the second user's selection. For example, if the second user wants to travel from the first floor of building 12 to the fourth floor without using scheduling device assembly 28, the second user will walk to elevator 16 located on the first floor, the second user's pick-up floor 14. Next, the second user will press the up arrow button 22′ (see, for example, FIG. 6a) located external to elevator 16. The second user must then wait for elevator 16 to travel to the first floor. Once elevator 16 arrives on the first floor, the second user will enter elevator 16. Then, the second user will select fourth floor button 22 by pressing selection mechanism 26 that works to transmit the second user's press to fourth floor button 22. Elevator 16 will travel to the fourth floor to drop off the second user at the user's indicated drop-off floor 10. Elevator controller 20′ allows the user to control elevator 16 via user's controller 32, while also allowing the second user to control elevator 16 without user's control 32. As discussed below, computer 34 may detect operation of elevator 16 when controller 20′ is not used to call an elevator car 15, in addition to knowing when controller 20′ and/or mobile user controller 32 are used to call an elevator car 15.

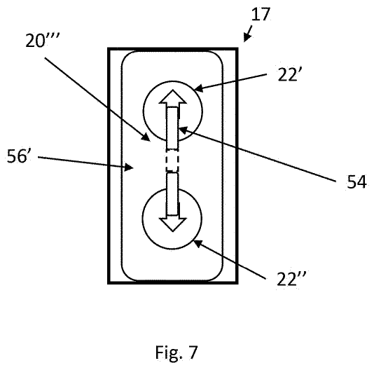

According to another embodiment, elevator controller 20″ is located outside elevator 16, next to and external to up/down button panel 17 as shown in FIGS. 6a and 6b. In another embodiment, elevator controller 20′″ is located directly on top of up/down button panel 17 as shown in FIG. 7. Elevator controllers 20″, 20′″ may be located proximately to up/down button panels 17 on each floor 10, 14 of building 12 so that a plurality of controllers 20″, 20′″ may be provided in building 12 for each elevator 12.

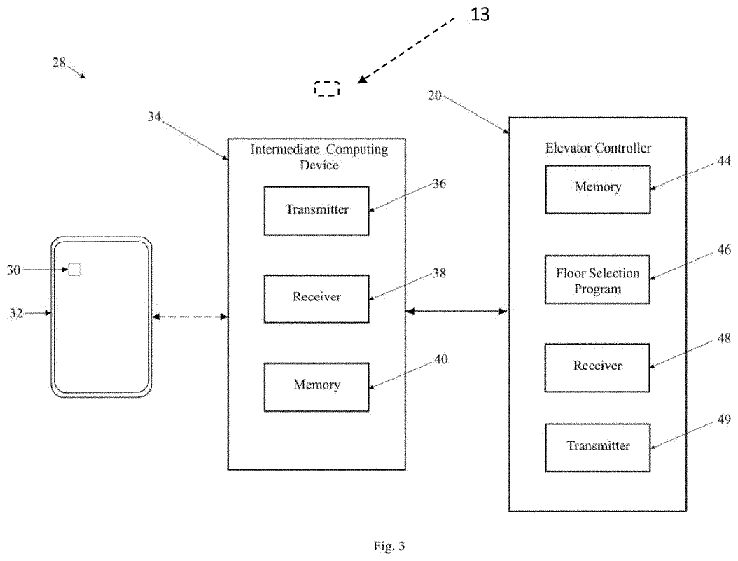

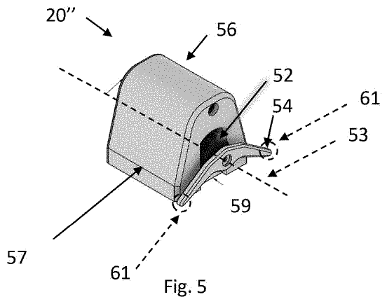

As shown in FIG. 5, elevator controller 20″ is an electromechanical nodal device with an actuator 52 that rotates attached selection blade/lever 54 about an axis of rotation 53. According to this embodiment, controller 20″ has a housing 56 including lid 57, back plate 58, and base 59. Elevator controller 20″ may have additional features that communicate with other components of scheduling device assembly 28, such as receiver 48 to field ticket information from intermediate computer device 34, local memory 44 to hold a ticket queue, and transmitter 49 (as shown in FIG. 3) to relay usage information back to computing device 34. Controller 20 may have sensors for detecting physical button pushes as discussed herein.

As shown in FIG. 6a, elevator controller 20″ is configured to make a binary selection, like that of an up/down button panel 17. FIG. 6b depicts controller 20″ in an installed position, external to panel 17. In response to an elevator call, motor 52 actuates lever 54 from a neutral position (depicted) to a biased position, either to press up button 22′ or down button 22″. Once lever 54 calls elevator car 15 by pressing either up or down buttons 22′, 22″, motor 52 actuates lever 54 from its biased position back to its neutral position. Lever 54 does not block a user from pressing up and down buttons 22′, 22″ allow a user to physically press up and down buttons 22′ and 22″ on panel 17. Thus, up and down buttons 22′, 22″ may be pressed by controller 20″ on physically by a user.

According to the present disclosure, elevator controller 20″ may be positioned in a variety of places to make button selections. FIGS. 6a and 6b show elevator controller 22′ proximate to up/down elevator panel 17. Buildings 12 with elevators 16 have multiple floors with up/down panels 17, thus elevator controllers 20″ may be placed at each floor 10, 14. Elevator controllers 20″ may also be placed inside an elevator car 15, proximate to floor selection panel 18. In this embodiment, a plurality of elevator controller 20″ may be placed in series to enable the selection of all elevator floor buttons 22 with a unifying logic component that controls all elevator controllers 20″ as a unit.

FIG. 7 depicts another embodiment of elevator controller 20′″ that fits over up/down panel 17. This embodiment also enables a second user to physically press the buttons underneath controller 20″. Controller 20′″ includes a housing 56′ that compliments the top of panel 17.

According to one embodiment, controller 20″ may include elevator movement input 61 that detects movement of elevator car 15 when a user physically presses a button 22′, 22″. Elevator movement input 61 may be a sensor that detect a user physically pressing up/down buttons 22′/22″, directly or indirectly through lever 54 on up/down button panel 17. The sensor may be a potentiometer, photosensor, thermocouple, pressure, thermistor, humidity sensor, accelerometer, capacitance, etc.

Upon sensing the pressing up/down buttons 22′/22″, transmitter 49 in elevator controller 20″ relays a signal indicative of the pressing to provide elevator movement acquired from the sensor to intermediate computing device/computer 34 to log elevator activity in addition to logging elevator activity controlled through controller 22″. Thus, computer 34 communicates with elevator movement input 61 to receive information from elevator movement input 61 to detect movement of the elevator car system (elevator car 15, cables, etc.) without communication from elevator control system 13 relating to control of elevator car system through elevator control system 13.

According to an alternative embodiment, elevator movement input 61 may be an accelerometer, piezoelectric devices, etc. that senses a vibration signature of an elevator car 15. When elevator car 15 moves up and down building 12, stop, etc., the vibrations of elevator 16 may be read by a movement sensor as elevator movement input. Recognizing the vibration signature of elevator car 15 as detected by input 61, elevator controller 20″ can detect when elevator car 15, moves past elevator movement input 61, stops at a floor 10, 14, etc. Transmitter 49 of elevator controller 20″ may relay movement input to computer 34 to log elevator activity in addition to logging elevator activity controlled through controller 22″. Inputs 61 may be placed directly in controller housing 56 (see FIG. 5), inside elevator 16, and exterior or interior to floor button panel 18, either visible or invisible, or outside elevator 16 on each floor of building 12, etc.

As shown in FIG. 3, elevator scheduling assembly 28 may include user's controller 32, such as a smartphone, intermediate computing device 34, and elevator controller 20, and elevator control system 13. Mobile user controller 32 includes a software application 30. Application 30 allows the user to call elevator 16. Intermediate computing device/computer 34 includes a transmitter 36, a receiver 38, and memory 40. Memory 40 stores instructions that cause intermediate computing device 34 to receive the elevator call from the user and create a ticket based on the elevator call. The ticket includes the user's pick-up floor 14, drop-off floor 10, and pick-up time. Receiver 38 receives the ticket from user's controller 32. Transmitter 36 sends the ticket to elevator controller 20. Elevator controller 20 includes memory 44, an elevator floor selection program 46, a receiver 48, and a transmitter 49 (wired, wireless, etc.). Memory 44 stores instructions that cause elevator controller 20 to add the ticket to a queue for elevator 16. Receiver 48 receives the ticket from intermediate computing device 32. Similar to intermediate computing device 34, elevator controller 20 may include transmitter 49. Elevator floor selection program 46 controls the selection of floor button 22 on floor button panel 18. For example, if the user is located on the first floor of building 12 and desires to travel to the fourth floor, elevator controller 20 will instruct electronically operated devices 21 associated with first floor button 22 to press first floor button 22 on floor button panel 18. Specifically, elevator floor selection program 46 of elevator controller 20 will instruct electronically operated devices 21 to press first floor button 22. Elevator 16 will travel to the first floor, the user's indicated pick-up floor 14, to pick up the user. Once elevator 16 picks up the user on the first floor, elevator floor selection program 46 of elevator controller 20 will instruct electronically operated devices 21 associated with fourth floor button 22 to press fourth floor button 22. As a result, elevator 16 will travel to the fourth floor, the user's indicated drop-off floor 10, to drop off the user.

As a component of elevator scheduling assembly 28, elevator control system 13 also controls operation of elevator 12, normally by the physical pressing of buttons 22, 22′, 22″. Often, elevator control system 13 is installed with the initial installation of elevator 16 and the remainder of elevator scheduling assembly 28 may be installed after, perhaps years or decades, the initial installation and subsequent operation of elevator 16. As discussed herein, elevator control system 13 may or may not communicate with the other components of elevator scheduling assembly 28 so that elevator control system 13 operates independently of the other components and vice versa

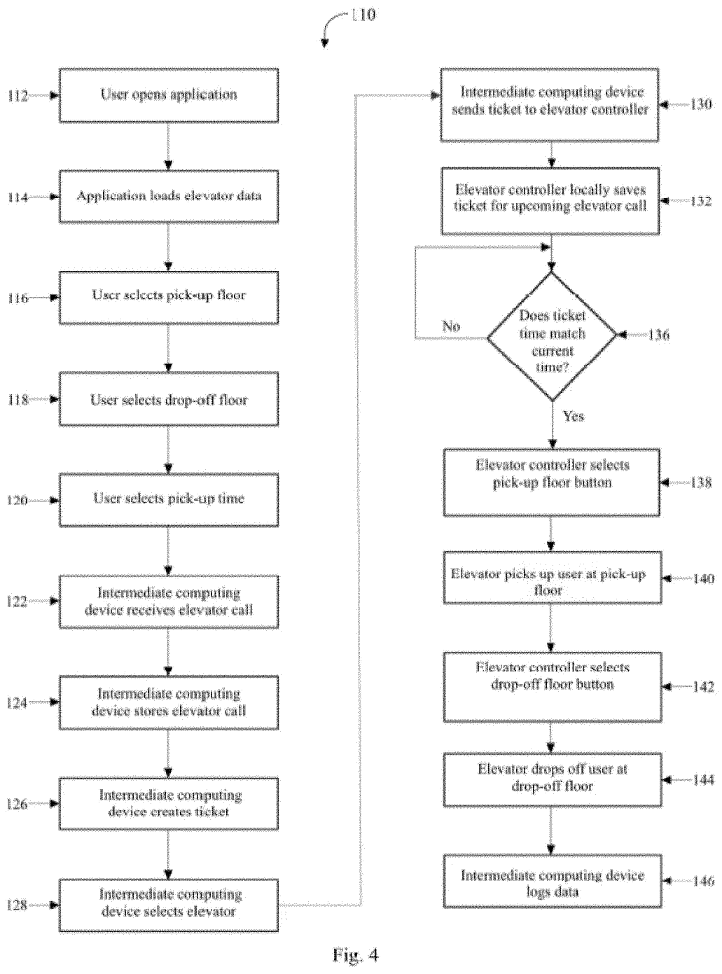

A diagrammatic representation of elevator scheduling method 110 is shown in FIG. 4. Method 110 begins at an opening step 112. In opening step 112, the user opens application 30 on user's controller 32. Application 30 may be accessed from a computer, such as a smartphone. Application 30 may be web-based or computer-based.

Next, in a loading step 114, application 30 loads elevator data. Application 30 shows what floor elevator 16 is located on in building 12. For example, if elevator 16 is on the fourth floor, application 30 indicates that elevator 16 is currently on the fourth floor. Loading step 114 performs active tracking of all elevators in building 12. If elevator 16 moves to a different floor while the user has application 30 open, this move will be reflected in application 30.

After loading step 114, method 110 progresses to a selecting pick-up step 116. In selecting pick-up step 116, the user selects the floor they want to be picked up on, also known as pick-up floor 14. Selecting pick-up step 116 ensures that elevator 16 travels to the user's desired floor. Pick-up floor 14 is the floor where the user will enter elevator 16.

After the user selects pick-up floor 14 in step 116, a selecting drop-off step 118 occurs. In selecting drop-off step 118, the user selects drop-off floor 10. Drop-off floor 10 is the floor where elevator 16 will drop the user off.

Next, a selecting time step 120 allows the user to select a time at which they desire to be picked up. This is known as the pick-up time. Once the user has selected pick-up floor 14, drop-off floor 10, and the pick-up time, in steps 116, 118, and 120, respectively, method 110 progresses to a receiving step 122.

In receiving step 122, intermediate computing device 34 receives the user's elevator call from application 30. Next, in a storing step 124, intermediate computing device 34 stores the elevator call. After intermediate computing device 34 stores the elevator call, intermediate computing device 34 creates the ticket for the elevator ride in a creating step 126.

During creating step 126, intermediate computing device 34 creates the ticket that includes pick-up floor 14, drop-off floor 10, and the user's pick-up time. These three components are all saved in the electronic ticket.

After the ticket is created in creating step 126, a selecting elevator step 128 occurs. In selecting elevator step 128, intermediate computing device 34 selects which elevator to send the ticket to.

Next, in a sending step 130, intermediate computing device 34 sends the ticket to elevator controller 20. Elevator controller 20 that the ticket is sent to is based on the elevator that was chosen by intermediate computing device 34 in selecting elevator step 128.

After intermediate computing device 34 sends the ticket to elevator controller 20 in sending step 130, a saving step 132 occurs. In saving step 132, elevator controller 20 locally saves the ticket for the user's upcoming elevator ride.

Next, in a timing decision step 136, elevator controller 20 determines whether the time on the ticket matches a current time. Elevator controller 20 compares the pick-up time that was saved on the ticket to the current time. If the pick-up time and the current time are substantially similar, then method 110 proceeds to a selecting pick-up floor button step 138. For example, if the pick-up time is 10:00 AM, and the current time is about 10:00 AM, then method 110 will proceed. If the pick-up time and the current time are not substantially similar, then method 110 does not yet proceed. For example, if the pick-up time is 10:00 AM, and the current time is 9:30 AM, method 110 does not proceed to selecting pick-up floor button step 138. Elevator controller 20 will continue to compare the pick-up time and the current time. Once the pick-up time and the current time are substantially similar, method 110 proceeds.

After elevator controller 20 determines that the pick-up time and the current time are substantially similar in timing decision step 136, elevator controller 20 selects pick-up floor 14 in selecting pick-up floor button step 138. Selecting pick-up floor button step 138 causes elevator 16 to travel to the user's pick-up floor 14. Elevator controller 20 sends a signal to elevator 16 to go to pick-up floor 14, mimicking the physical pressing of floor button 22.

In a picking up step 140, elevator 16 picks up the user at pick-up floor 14. Next, in a selecting drop-off floor button step 142, elevator controller 20 selects drop-off floor 10, causing elevator 16 to travel to the user's drop-off floor 10. Elevator controller 20 sends a signal to elevator 16 to go to drop-off floor 10, mimicking the physical pressing of floor button 22. After selecting drop-off floor button step 142, a dropping off step 144 occurs.

In dropping off step 144, elevator 16 drops the user off at drop-off floor 10. Lastly, in a logging step 146, intermediate computing device 34 logs data regarding the user's interaction with elevator 16. The user's information, including the user's name, is logged by intermediate computing device 34. The user's ticket information, including pick-up floor 14, drop-off floor 10, and the pick-up time, is also logged by intermediate computing device 34. Intermediate computing device 34 also logs any data pertaining to necessary maintenance of elevator 16. For example, if a component of elevator 16 is not functioning properly, intermediate computing device 34 logs this data. The data may be used to determine where the user has been in building 12 and where they went in building 12. The data may also be used to determine when the elevators in building 12 are busy throughout the day.

According to the present disclosure, data logging step 146 may be used to gather information of elevator(s) 16 in response to both standard physically pressing the buttons by a user (directly or indirectly) and controllers 20, 20′, 20″, 20′″, etc. Tracking the combination of calls from elevator scheduling method 110 and those made by standard use facilitates accurate accounting of elevator calls. Often elevators are serviced at set intervals based on the number of trips an elevator makes (e.g., every 1,000) or a set time period (e.g. every three months). However, inaccurate recordation of the number, if any, of elevator trips or variations in the number of calls in set time periods may lead to imprecise servicing intervals. For example, if an elevator 16 should be serviced every 1,000 trips, a time period may be set at two months, anticipating that more than 1,000 trips is highly unlikely to occur during the two-month period. However, elevator 16 may have only taken 500 trips during the two-month service interval, resulting in servicing elevator 16 too soon. Additionally, it is possible that elevator 16 may have taken 1,200 trips during the two-month service interval, resulting in servicing elevator 16 late.

The present disclosure reduces cost associated with too frequent servicing and reduces the danger of too little servicing by computer 34 logging both trips logged through controllers 20, 20′, 20″, 20′″, etc. and physical pressing of buttons, 22, 22′, 22″.

Computer 34 may use data acquired from logging step 146 to analyze patterns of high elevator use and optimize elevator movement accordingly. For example, occupants of building 12 may routinely use elevator 16 at lunchtime when elevator cars 15 are more likely to move from higher floors to lower floors. Computer 34 will recognize this timing pattern of higher movement in one direction and schedule a call to pick-up passengers at a high floor, such as the top floor of building 12 at or slightly before a time of high elevator down movement. As the elevator descends, passengers from each floor can be picked up in the same trip, thereby increasing elevator efficiency by avoiding picking up passenger at lower floors prior to going down only to pick up passengers at a higher floor and go down again. By precisely tracking elevator information and using that information to reduce the number of trips the elevator takes, elevator owners can minimize the cost associated with elevator use and maintenance.

When the user is ready to call elevator 16 for another elevator ride, the user may reopen application 30 on user's controller 32, as in opening step 112 of method 110. The user then proceeds through method 110 to schedule the elevator ride. While the user is using application 30, the second user and other users may continue to use elevator 16 by pressing the up/down arrows and floor button 22 on floor button panel 18.

What is claimed is:

1. An elevator scheduling assembly, comprising
a computer configured to control elevator calls and
an elevator controller positionable to operate an elevator button to call an elevator car to a floor of a building in response to instructions from the computer.

2. The elevator scheduling assembly of claim 1, wherein the elevator controller is one of a plurality of elevator controllers positionable to operate elevator buttons to call an elevator car to floors of the building in response to instructions from the computer.

3. The elevator scheduling assembly of claim 2, wherein the plurality of elevator controllers are positionable adjacent to up and down elevator buttons.

4. The elevator scheduling assembly of claim 2, wherein the plurality of elevator controllers are positionable adjacent to numbered floor elevator buttons.

5. The elevator scheduling assembly of claim 1, wherein the elevator controller includes a housing sized to compliment an elevator button panel and an actuator supported by the housing and operate the elevator button.

6. The elevator scheduling assembly of claim 1, further comprising a mobile user controller having a software application defining a user interface that communicates scheduling information to the computer.

7. The elevator scheduling assembly of claim 6, wherein the user interface includes a pick-up floor input, a drop-off floor input, and a pick-up time input.

8. The elevator scheduling assembly of claim 7, wherein the computer has memory and is program to compare the current time with a time received by the pick-up time input.

9. The elevator scheduling assembly of claim 1, wherein the actuator includes an elevator movement input and the computer includes a receiver configured to receive signals from the actuator indicative of movement of an elevator car.

10. (canceled)

11. (canceled)

12. An elevator, comprising
an elevator car system,
an elevator control system configured to control the elevator car system,
an elevator movement input, and
a computer in communication with the elevator movement input to receive information from the elevator movement input to detect movement of the elevator car system without communication from the elevator control system relating to control of elevator car system through elevator control system.

13. The elevator of claim 12, wherein the elevator movement input is an accelerometer positioned to measure a vibration signature of an elevator car and the elevator controller further includes a transmitter configured to transmit information from the accelerometer.

14. The elevator of claim 13, wherein the accelerometer to detects at least one of the arrival, passing through, and departure of the elevator car.

15. An elevator, comprising
an elevator car system,
an elevator control system configured to control the elevator car system,
an elevator controller including a receiver configured to receive an elevator call signal and an actuator in communication with the receiver and positionable to press an elevator button in response to receiving the elevator call signal, the elevator controller including an elevator movement input, and
a plurality of doors positioned on floors of a building, the elevator control system includes a plurality of elevator buttons including up and down elevator buttons positioned adjacent to the plurality of doors, the elevator movement input being, positioned to detect movement of the elevator car system relative to a floor of the building.

16. The elevator of claim 15, wherein the elevator movement input includes a sensor positioned to detect pressing of at least one of the plurality of elevator buttons and the elevator controller further includes a transmitter configured to transmit information from the sensor.

17. The elevator of claim 15, further comprising a plurality of elevator controllers including a receiver configured to receive an elevator call signal and an actuator in communication with the receiver and positionable to press an elevator button in response to receiving the elevator call signal, wherein the elevator controllers include an elevator movement input, each of the plurality of elevator controllers is positioned proximate a floor of the building.

18. The elevator of claim 17, wherein the elevator movements inputs are accelerometers positioned to measure a vibration signature of an elevator car and the elevator controller further includes at least one transmitter configured to transmit information from at least one of the accelerometers.

19. (canceled)
